(19) United States
(12) Patent Application Publication
(10) Pub. No.: US 2026/0112204 A1
(43) Pub. Date: Apr. 23, 2026

(54) METHOD AND APPARATUS FOR INTERACTION BETWEEN INTELLIGENT WEARABLE DEVICE AND MOBILE TERMINAL, COMPUTER DEVICE, AND STORAGE MEDIUM

(71) Applicant: META-BOUNDS INC., Zhuhai (CN)

(72) Inventors: Jiahao YE, Zhuhai (CN); Yiran HUANG, Zhuhai (CN)

(21) Appl. No.: 19/424,350

(22) Filed: Dec. 18, 2025

Related U.S. Application Data
(63) Continuation of application No. PCT/CN2024/099649, filed on Jun. 17, 2024.

(30) Foreign Application Priority Data
Sep. 27, 2023 (CN) 2023112621134

(51) Int. Cl. G06V 40/20; G06F 3/01; G06V 10/44

(52) U.S. Cl. CPC G06V 40/28; G06F 3/017; G06V 10/443

(57) ABSTRACT

The present disclosure provides a method for interaction between an intelligent wearable device and a mobile terminal. The method includes: collecting corner point coordinates of a target corner point on a mobile terminal, determining a target extended screen component on which the current user wants to operate, collecting the current gesture action of the current user, generating a corresponding component operation instruction, and executing a target operation on the target extended screen component.

### CROSS-REFERENCE TO RELATED APPLICATIONS

The application is a National Stage of International Application No. PCT/CN2024/099649, filed on Jun. 17, 2024, which claims the priority to Chinese Patent Application No. 2023112621134, entitled "METHOD AND APPARATUS FOR INTERACTION BETWEEN INTELLIGENT WEARABLE DEVICE AND MOBILE TERMINAL, AND DEVICE AND MEDIUM", and filed on Sep. 27, 2023, the entire contents of both of which are incorporated herein by reference.

### TECHNICAL FIELD

The present disclosure relates to the field of intelligent wearable technology, and in particular, to a method and an apparatus for interaction between intelligent wearable device and mobile terminal, a computer device, and a storage medium.

### BACKGROUND

An extended screen is a fast application engine running on an intelligent large-screen device, providing a new multi-screen interaction mode. It can be launched and interacted with by mobile client applications or mini-programs in a manner similar to screen casting, and can also be directly operated and interacted with using a large-screen remote control. The extended screen is a mapping of the mobile terminal's application interface onto the display interface of the intelligent wearable device, facilitating the rapid display of the mobile terminal's services and content on the large screen, thereby significantly reducing the development, promotion, and maintenance costs of large-screen applications.

### SUMMARY OF THE INVENTION

The present disclosure provides a method and an apparatus for interaction between intelligent wearable device and mobile terminal, a device, and a storage medium.

In a first aspect, the present disclosure provides a method for interaction between an intelligent wearable device and a mobile terminal, the method includes:

detecting, by the intelligent wearable device, a current attitude of the mobile terminal, when the intelligent wearable device and the mobile terminal are in an extended screen interaction state;

acquiring corner point coordinates of a target corner point on the mobile terminal, when it is detected that the current attitude of the mobile terminal matches a preset interaction operation action;

determining a target extended screen component, based on an extended screen component region corresponding to the corner point coordinates; and

executing a target operation on the target extended screen component based on a component operation instruction corresponding to a preset gesture operation action, when a current gesture action of a current user matches the preset gesture operation action.

In a second aspect, the present disclosure further provides an apparatus for interaction between an intelligent wearable device and a mobile terminal, the apparatus includes:

one or more processors; and

a memory, configured to store one or more programs, in which the one or more programs, when executed by the one or more processors, cause the one or more processors to execute operations of:

detecting a current attitude of the mobile terminal when the intelligent wearable device and the mobile terminal are in an extended screen interaction state;

acquiring corner point coordinates of a target corner point on the mobile terminal when it is detected that the current attitude of the mobile terminal matches a preset interaction operation action;

determining a target extended screen component based on an extended screen component region corresponding to the corner point coordinates; and

executing a target operation on the target extended screen component based on a component operation instruction corresponding to the gesture operation action when a current gesture action of a current user matches a preset gesture operation action.

In a third aspect, the present disclosure further provides a computer device, the computer device includes a processor, a memory, and a computer program stored on the memory and executable by the processor, when the computer program is executed by the processor, the steps of the method for interaction between an intelligent wearable device and a mobile terminal as described above are implemented.

In a fourth aspect, the present disclosure further provides a non-transitory computer-readable storage medium, the computer-readable storage medium having stored thereon a computer program, when the computer program is executed by a processor, the steps of the method for interaction between an intelligent wearable device and a mobile terminal as described above are implemented.

### BRIEF DESCRIPTION OF THE DRAWINGS

In order to more clearly illustrate the technical solutions of the embodiments of the present disclosure, the following will briefly introduce the drawings needed in the description of the embodiments. Obviously, the drawings in the following description are some embodiments of the present disclosure, and those skilled in the art would be able to derive other drawings from these drawings without any creative efforts.

FIG. 1 is a schematic flowchart of a method for interaction between an intelligent wearable device and a mobile terminal according to a first embodiment of the present disclosure;

FIG. 2 is a schematic flowchart of a method for interaction between an intelligent wearable device and a mobile terminal according to a second embodiment of the present disclosure;

FIG. 3 is a schematic detailed flowchart of a first step of the method for interaction between an intelligent wearable device and a mobile terminal according to a second embodiment of the present disclosure;

FIG. 4 is a schematic flowchart of a method for interaction between an intelligent wearable device and a mobile terminal according to a third embodiment of the present disclosure;

FIG. 5 is a distribution schematic diagram of an extended screen component in an activated extended screen mode according to an embodiment of the present disclosure;

FIG. 6 is a distribution schematic diagram of a relative coordinate relationship between an extended screen component region and a mobile terminal according to an embodiment of the present disclosure;

FIG. 7 is a distribution schematic diagram of a relative size relationship between second size information of an extended screen component and first size information of a mobile terminal according to an embodiment of the present disclosure;

FIG. 8 is another distribution schematic diagram of a relative size relationship between second size information of an extended screen component and first size information of a mobile terminal according to an embodiment of the present disclosure;

FIG. 9 is a schematic structural diagram of an interaction apparatus for an intelligent wearable device and a mobile terminal according to a first embodiment of the present disclosure;

FIG. 10 is a schematic block diagram of a structure of a computer device according to an embodiment of the present disclosure.

The realization of the objectives, functional features, and advantages of the present disclosure will be further explained with reference to the embodiments and accompanying drawings.

### DETAILED DESCRIPTION OF EMBODIMENTS

The technical solutions in the embodiments of the present disclosure will be clearly and completely described below with reference to the accompanying drawings in the embodiments of the present disclosure. Obviously, the described embodiments are part of the embodiments of the present disclosure, but not all of them. Based on the embodiments in the present disclosure, all other embodiments obtained by those skilled in the art without creative effort shall fall within the scope of protection of the present disclosure.

The flowcharts shown in the accompanying drawings are for illustrative purposes, and do not have to include all content and operations/steps, nor is it necessary to be executed in the order described. For example, some operations/steps can be decomposed, combined, or partially merged, so the actual execution order may change according to the actual situation.

An intelligent wearable devices can achieve extended screen interaction with mobile terminals based on augmented reality technology, mapping the desktop applications of the mobile terminal onto the display interface of the intelligent wearable device. Although intelligent wearable devices currently achieve extended screen display of mobile terminal desktop applications, they cannot directly operate the extended screen components within the display interface, resulting in an interaction effect between the intelligent wearable device and the mobile terminal that fails to meet user demands, and leading to a poor user experience with the interaction functionality between the intelligent wearable device and the mobile terminal.

Therefore, how to improve the user experience of the interaction functionality between intelligent wearable devices and mobile terminals has become a technical problem urgently needing to be solved.

Some embodiments of the present disclosure are described in detail below with reference to the accompanying drawings. In the case of no conflict, the features in the following embodiments can be combined with each other.

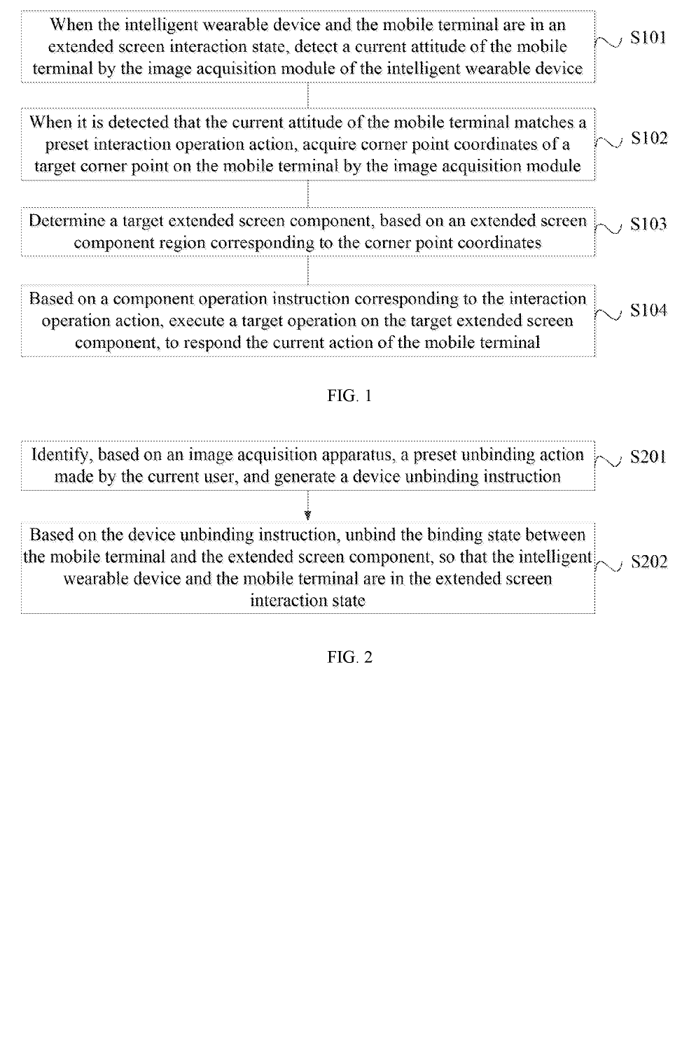

Referring to FIG. 1. FIG. 1 is a schematic flowchart of a method for interaction between an intelligent wearable device and a mobile terminal according to a first embodiment of the present disclosure.

As shown in FIG. 1, the method for interaction between the intelligent wearable device and the mobile terminal includes steps S101 to S104.

Step S101: When the intelligent wearable device and the mobile terminal are in an extended screen interaction state, detect a current attitude of the mobile terminal by the intelligent wearable device.

In some embodiments, the intelligent wearable device refers to a wearable glasses device with an independent operating system that can implement various functions through software installation. For example, AR glasses (Augmented Reality goggles), VR glasses (Virtual Reality), AR helmets, etc.

In some embodiments, a mobile terminal, that is a mobile communication terminal, refers to a computer device that can be used while moving, including mobile phones, notebooks, tablet computers, etc.

In some embodiments, the intelligent wearable device can detect the current attitude of the mobile terminal through an image acquisition apparatus. The image acquisition apparatus refers to a device component capable of image acquisition and image processing, such as a camera, an infrared sensor, a laser scanner, etc. The image acquisition apparatus may be carried by the intelligent wearable device itself, or may be an independent device installed on the intelligent wearable device.

In some embodiments, the image acquisition apparatus is communicatively connected to the intelligent wearable device and is used to acquire images or video data of the mobile device and the user's hand, and according to the acquired image and video data, identify the attitude, coordinates, and actions of the mobile device and the user's hand. When the image acquisition apparatus identifies that the mobile terminal has moved into the collection image of the image acquisition apparatus, it can identify contour information and corner point coordinate information of the mobile terminal, and can also track and identify movement trajectory information of the mobile terminal.

Step S102: When it is detected that the current attitude of the mobile terminal matches a preset interaction operation action, acquire corner point coordinates of a target corner point on the mobile terminal.

In some embodiments, the display interface of the intelligent wearable device can be taken as a two-dimensional coordinate system. The upper left corner of the display interface can be taken as the origin of the coordinate system, and the two sides of the display interface can be taken as the coordinate axes of the two-dimensional coordinate system. The scales of the coordinate axes are set according to the length and width of the display interface. Thus, the contour coordinates and corner point coordinates of the mobile terminal can be tracked in the display interface of the intelligent wearable device.

In some embodiments, the image acquisition apparatus of the intelligent wearable device can track and calculate the contour and corner point coordinates of the mobile terminal in real time. When it is detected that the current attitude of the mobile terminal matches the interaction operation action, that is, the similarity between the current attitude and the interaction operation action is greater than or equal to a similarity threshold (e.g., 90%), the image acquisition apparatus is used to acquire the current corner point coordinates of the mobile terminal. The interaction operation action may include a double-tap action, a hold gesture maintained for a preset duration, a slide action, etc.

In some embodiments, the corner point coordinates of the mobile terminal can be determined based on the contour coordinates of the mobile terminal, representing the edge lines of each side of the mobile terminal. The intersection point of two intersecting edge lines can be taken as the corner point coordinates of the mobile terminal.

In some embodiments, the four corners of the mobile terminal are generally designed as arcs. Based on the contour coordinates of the mobile terminal, the intersection coordinates of each edge line of the mobile terminal can be calculated. The four intersection points correspond to the four arc corners of the mobile terminal respectively. The arc point on each arc corner that is closest to the corresponding intersection coordinate can be taken as the corner point.

In some embodiments, the mobile terminal generally has four sides, that is, the corner point coordinates of the four corners of the mobile terminal can be tracked. To improve the recognition accuracy of the extended screen component, one of the four corner points can be preset as the target corner point for tracking, such as the upper left corner of the mobile terminal.

In some embodiments, the intelligent wearable device can identify the contour of the mobile terminal through the image acquisition apparatus, and activate the extended screen function of the mobile terminal, thereby achieving extended screen interaction between the intelligent wearable device and the mobile terminal. In the extended screen interaction state, the intelligent wearable device acquires the corner point coordinates of the mobile terminal through the image acquisition apparatus, such as the corner point coordinates of the upper right corner.

Step S103: Determine a target extended screen component, based on an extended screen component region corresponding to the corner point coordinates.

In some embodiments, when it is detected that the current attitude of the mobile terminal matches the preset interaction operation action, the corner point coordinates of the target corner point of the mobile terminal are simultaneously acquired. The extended screen component region where the corner point coordinates of the target corner point are located is determined as the target region. The target extended screen component corresponding to this region is the extended screen component that the current user intends to operate. The extended screen component is a high-performance cross-terminal development framework for intelligent large-screen devices,a fast application engine running on the intelligent wearable device, which can help developers quickly build application services for the intelligent wearable device and provide multi-screen interaction capabilities.

In some embodiments, the extended screen component can be a mapping of the mobile terminal's application interface onto the display interface of the intelligent wearable device, facilitating the rapid display of the mobile terminal's services and content on the display interface of the intelligent wearable device. The extended screen component includes application components of the mobile terminal, used to display the application display content of the mobile terminal, such as videos played by video software, real-time bullet comments; reading pages of novel software, etc.

In some embodiments, the extended screen component also includes functional module components of the intelligent wearable device, facilitating users to query and call functions and services of the intelligent wearable device, such as product descriptions, connectable device lists, network lists, etc.

In some embodiments, the method for interaction between the intelligent wearable device and the mobile terminal further includes: identifying a current interaction action of the current user operating the mobile terminal based on the corner point coordinates. When the current interaction action satisfies a trigger condition corresponding to the preset interaction operation action, the intelligent wearable device can determine that the current interaction action is the interaction operation action.

In some embodiments, the interaction operation action can be identified based on the coordinates of a preset corner of the mobile terminal. For example, the current user operates the mobile terminal to perform a double-tap action, that is, the coordinate values of the target corner point of the mobile terminal point to the same coordinate position within a preset time. When the image acquisition apparatus identifies a tapping action at a corner of the mobile terminal, it acquires the landing point coordinates of the target corner point during the tapping action; if this landing point coordinate is located within a certain extended screen component region, it is determined that the extended screen component corresponding to that extended screen component region is the target extended screen component. When it is identified that the corner point coordinates of the target corner point stay in a certain extended screen component region for a duration reaching a preset threshold, it can be determined that the extended screen component corresponding to that extended screen component region is the target extended screen component that the current user wants to view or perform an operation on.

In some embodiments, when it is detected that the current user operates the mobile terminal to perform an interaction operation action, but the coordinate region corresponding to the corner point coordinates does not belong to any extended screen component region, it can be determined that the interaction operation action is invalid, and no operation instruction is generated.

In some embodiments, when it is detected that the current user operates the mobile terminal to perform an interaction operation action, but the coordinate region corresponding to the corner point coordinates does not belong to any extended screen component region, the distances between the corner point coordinates and the midpoint position of each extended screen component region can also be calculated, and a shortest distance among the distances can be identified, the extended screen component region corresponding to the shortest distance is determined as the landing point region of the corner point coordinates, thereby determining the extended screen component corresponding to this landing point region as the target extended screen component.

In some embodiments, the extended screen component region is the display region of each extended screen component in the display interface of the intelligent wearable device. The display interface is taken as a two-dimensional coordinate system, the four corner point coordinates of the extended screen component region can be determined, and then the side lengths of the extended screen component region can be calculated based on the four corner point coordinates. For example, the coordinate distance between two corner point coordinates in the same row is the length of the extended screen component region, and the coordinate distance between two corner point coordinates in the same column is the width of the extended screen component region. Thus, based on the coordinate relationship between the corner point coordinates and the regional coordinates of the extended screen component region, it can be determined whether the coordinate region corresponding to the corner point coordinates belongs to an extended screen component region. When the corner point coordinates are located within the range of any extended screen component region, it is determined that the coordinate region corresponding to the corner point coordinates belongs to an extended screen component region; when the corner point coordinates are not within the range of any extended screen component region, it is determined that the coordinate region corresponding to the corner point coordinates does not belong to any extended screen component region.

Step S104: When a current gesture action of a current user matches a preset gesture operation action, execute a target operation on the target extended screen component based on a component operation instruction corresponding to the preset gesture operation action.

In some embodiments, the current gesture action of the current user can be acquired through an image acquisition module. The current user can perform a preset gesture operation action within the collection image of the image acquisition module, so that the intelligent wearable device can identify the current user's operation on the target extended screen component.

In some embodiments, the preset gesture operation action may include gestures made by a single finger, multiple fingers, or the entire hand, such as a double-tap action of the thumb, a slide action of the index finger fingertip, etc.

In some embodiments, the method for interaction between the intelligent wearable device and the mobile terminal further includes: obtaining a preset gesture instruction library, in which the gesture instruction library includes at least one the gesture operation action and the component operation instruction corresponding to each the gesture operation action; based on a gesture recognition algorithm, comparing the current gesture action with each the gesture operation action in the gesture instruction library to determine a similarity between the current gesture action and each the gesture operation action; when the similarity is greater than or equal to a preset similarity, determining the gesture operation action matching the current gesture action based on the similarity.

In some embodiments, based on at least one component operation instruction of the extended screen component, a gesture operation action corresponding to each component operation instruction can be preset. The intelligent wearable device can pre-record gesture operation actions through the image acquisition apparatus, and uniquely associate each gesture operation action with the corresponding component operation instruction, so that each component operation instruction corresponds to one gesture operation action, and store them in the data storage module of the intelligent wearable device to obtain the gesture instruction library.

In some embodiments, one component operation instruction can also correspond to multiple different gesture operation actions. For example, a component detail page viewing instruction can correspond to a double-tap action; the double-tap action can be a double-tap action of the thumb fingertip, or a double-tap action of the index finger fingertip.

In some embodiments, the same gesture operation action can also correspond to multiple component operation instructions. For example, both a component detail page viewing instruction and a component detail page exit instruction can correspond to a double-tap action. When a double-tap action is detected outside the component detail page (i.e., not entered the component detail page), a component detail page viewing instruction is generated; when a double-tap action is detected inside the component detail page (i.e., already in the component detail page), a component detail page exit instruction is generated.

In some embodiments, a gesture recognition algorithm can be used to calculate the action trajectory of the current gesture action, and then compare the action trajectory with the action trajectories of each gesture operation action in the gesture instruction library, calculating the similarity between the action trajectory of the current gesture action and the action trajectories of each gesture operation action.

When the similarity between the action trajectory of the current gesture action and the action trajectory of a certain gesture operation action is greater than or equal to the preset similarity, it is determined that the current gesture action is that gesture operation action, and the current gesture action and the gesture operation action are matched. When the similarity between the action trajectory of the current gesture action and the action trajectories of each gesture operation action in the gesture instruction library is less than the preset similarity, it is determined that the current gesture action does not match any gesture operation action, and no component operation instruction can be generated.

In some embodiments, when the similarity between the action trajectory of the current gesture action and the action trajectories of multiple gesture operation actions is greater than or equal to the preset similarity, it is determined that the gesture operation action with the highest similarity matches the current gesture action. The action trajectory of the current gesture action can be the coordinate trajectory of hand key points (joint points, fingertips, etc.) over a time sequence.

In some embodiments, when it is detected that the current gesture action matches the preset gesture operation action, the intelligent wearable device generates a corresponding component operation instruction based on the gesture operation action, and executes a corresponding operation on the target extended screen component according to the component operation instruction.

In some embodiments, when it is detected that the current gesture action matches the preset gesture operation action, the intelligent wearable device can determine the component operation instruction corresponding to the current gesture operation action based on the preset gesture instruction library, and then generate this component operation instruction. For example, a tap action can represent entering the component detail page, generating an open instruction for the extended screen component's detail page at this time; a slide action represents exiting the component detail page, generating an exit instruction for the extended screen component's detail page at this time, etc.

In some embodiments, when a double-tap action corresponds to a component viewing instruction of the extended screen component, based on the target extended screen component pointed to by the double-tap action, a viewing instruction for that target extended screen component is generated, such as the component operation instruction "Music Player - View". Then, based on this component operation instruction, one can enter the detail page of the music player extended screen component.

When a slide action corresponds to a switching instruction of the extended screen component, when it is detected that the mobile terminal performs a slide action in the current extended screen component detail page, a component detail page switching instruction is generated, switching the current extended screen component detail page to another extended screen component detail page.

In a specific embodiment, the process of executing the target extended screen component operation based on the current user's current gesture action can be as follows: when the thumb double-taps the extended screen component, it indicates the intention to view the detail page of that extended screen component. When the image acquisition module identifies that the user's thumb performs a double-tap action on the component page, the gesture operation action (thumb-double tap) corresponding to this double-tap action is matched from the gesture instruction library. The intelligent wearable device generates the component operation instruction (enter component detail page instruction) corresponding to this gesture operation action, and enters the detail page of the target extended screen component based on this component operation instruction. Then, within the detail page of the target extended screen component, when the user's gesture is captured making a slide action (corresponding to the component switching instruction gesture), the intelligent wearable device generates a component switching instruction, switching to display the detail page of the next extended screen component. When the user's thumb is captured making a double-tap action within the detail page of the extended screen component, at this time, based on the matching of "component detail page—double-tap action—exit component detail page", a back instruction can be determined, and based on the back instruction, the currently displayed extended screen component's detail page is exited.

This embodiment provides a method for interaction between an intelligent wearable device and a mobile terminal. In this method, when the intelligent wearable device and the mobile terminal are in an extended screen interaction state, the image acquisition apparatus is used to detect the current attitude of the mobile terminal, and when the current attitude matches a preset interaction operation action, the operation recognition process for the extended screen component is triggered, improving the accuracy of component operation and avoiding false triggering of operations. By using the image acquisition apparatus to acquire the corner point coordinates of the target corner point on the mobile terminal, the target extended screen component that the current user intends to operate is determined based on the extended screen component region where the corner point coordinates are located, thereby achieving precise identification and selection of the extended screen component. Based on the identified interaction operation action, a corresponding component operation instruction is generated, and based on the component operation instruction, the target operation is executed on the target extended screen component, allowing the current user to directly operate the extended screen component on the display interface of the intelligent wearable device, thereby improving the interaction efficiency between the intelligent wearable device and the mobile terminal and enhancing the user experience.

Referring to FIG. 2. FIG. 2 is a schematic flowchart of a method for interaction between an intelligent wearable device and a mobile terminal according to a second embodiment of the present disclosure.

As shown in FIG. 2, based on the embodiment shown in FIG. 1, before step S101, the method further includes:

Step S201: Identify, based on an image acquisition apparatus, a preset unbinding action made by the current user, and generate a device unbinding instruction.

In some embodiments, in the extended screen mode, the mobile terminal and the extended screen component are in a bound state. At this time, when the mobile terminal moves, the extended screen component moves synchronously with it, anchored around the mobile terminal. At this time, the current user can control the extended screen component by operating the desktop applications on the mobile terminal's screen. To operate the extended screen component on the display interface of the intelligent wearable device, the binding between the mobile terminal and the extended screen component needs to be unbound.

In some embodiments, a preset unbinding action can be designed to unbind the binding state between the mobile terminal and the extended screen component. For example, a double-tap action within the screen area of the mobile terminal.

In some embodiments, when the image acquisition apparatus of the intelligent wearable device identifies that the current user has made the preset unbinding action, an unbinding event between the mobile terminal and the extended screen component is triggered. The intelligent wearable device generates a device unbinding instruction to unbind the binding state between the mobile terminal and the extended screen component.

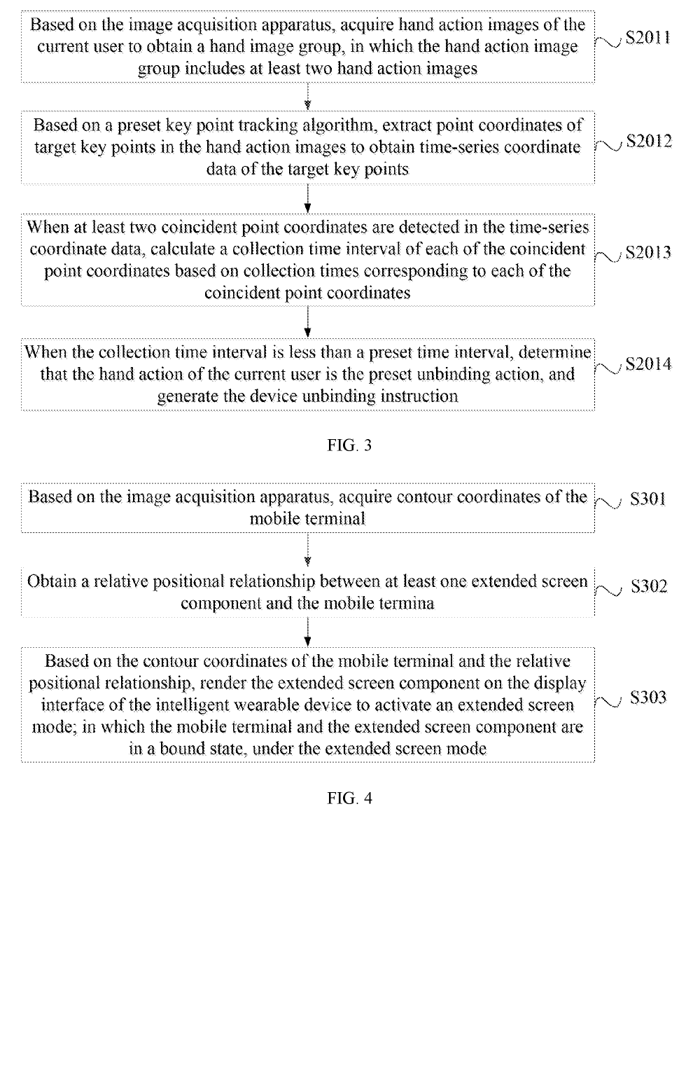

In some embodiments, as shown in FIG. 3, step S201 includes:

Step S2011: Based on the image acquisition apparatus, acquire hand action images of the current user to obtain a hand image group, in which the hand action image group includes at least two hand action images.

In some embodiments, the hand action images of the current user can be acquired through the image acquisition apparatus of the intelligent wearable device to obtain a hand action image group. The image group can be in the form of a video stream, i.e., a set of hand action images captured in time sequence.

In some embodiments, the frame rate of the image acquisition apparatus can be set according to the tracking effect of the hand action. For example, the frame rate can be set to 25 FPS (frames per second), that is, 25 frames of images are captured per second. This ensures that the user's hand action can be complete captured, thereby reducing the processing load of image data, and improving the recognition efficiency and action response efficiency of the hand action.

Step S2012: Based on a preset key point tracking algorithm, extract point coordinates of target key points in the hand action images to obtain time-series coordinate data of the target key points.

In some embodiments, the time-series coordinate data refers to the time series data of the point coordinates of the target key points. Time series data is a series of data obtained in different time periods or at different time points in chronological order, describing the change of the observed object over time.

In some embodiments, according to a preset key point tracking algorithm, target key points in each hand action image are extracted, such as finger fingertips, joint points, etc., and the point coordinates of the target key points are tracked and calculated to obtain a set of coordinate change data of the target key points in time sequence.

Step S2013: When at least two coincident point coordinates are detected in the time-series coordinate data, calculate a collection time interval of each of the coincident point coordinates based on collection times corresponding to each of the coincident point coordinates.

In some embodiments, when at least two coincident point coordinates are detected in the time-series coordinate data, it means that the current user has clicked the same location at least twice. At this time, according to the time-series coordinate data, the coordinate collection time of each coincident point coordinate is determined, and then the collection time interval of each coincident point coordinate is calculated.

In some embodiments, coincident point coordinates can be two point coordinates that are exactly the same, or two point coordinates whose distance is less than a set value. For example, two point coordinates with a distance less than 5 pixel distances can be considered coincident point coordinates.

Step S2014: When the collection time interval is less than a preset time interval, determine that the hand action of the current user is the preset unbinding action, and generate the device unbinding instruction.

In some embodiments, the preset time interval is set according to the preset unbinding action. When the preset unbinding action is a double-tap action, the preset time interval for determining a double-tap action can be set to 1 second, meaning that when the current user is detected clicking the same location twice within 1 second, the preset unbinding action is triggered.

In some embodiments, when the collection time interval of each coincident point coordinate is less than the preset time interval, it can be determined that the hand action of the current user has triggered the preset unbinding action. At this time, the intelligent wearable device generates the device unbinding instruction, and unbinds the binding state between the mobile terminal and the extended screen component according to the unbinding instruction.

In some embodiments, a double-tap action is a quick and continuous two clicks within the same area range. A hand key point algorithm can be used to obtain 21 key points of the human hand. The position coordinates of the thumb fingertip and the first joint point are tracked in each frame. If the interval time is defined as t frames, when the thumb fingertip and the thumb first joint appear twice at the same position within t frames and the thumb is within the screen area of the mobile terminal, the preset unbinding action is triggered, that is, the binding state between the mobile terminal and the extended screen component is unbound.

In some embodiments, the area range can be a region centered on the landing point coordinate of the first click, radiating outward a certain coordinate distance, i.e., determined by the coordinate distance between the landing point coordinates of two consecutive clicks. For example, taking the landing point coordinate of the first click as the reference point, when the coordinate distance between the landing point coordinate of the second click and this reference point is less than or equal to a limit value (e.g., five pixel distances), and the time interval between the two clicks is within t frames (including t frames), it can be determined as a double-tap action.

In some embodiments, when the collection time interval is greater than the preset time interval, it is determined that the hand action of the current user has not triggered the preset unbinding action. At this time, the intelligent wearable device does not respond and continues to acquire the user's hand action images through the image acquisition module.

In some embodiments, after detecting at least two coincident point coordinates in the time-series coordinate data, the method further includes: based on the time-series coordinate data, determining an interval frame number between the hand action images corresponding to each of the coincident point coordinates; and when the interval frame number is less than a preset interval frame number, determining that the hand action of the current user is the preset unbinding action, and generating the device unbinding instruction.

In some embodiments, the images acquired by the image acquisition apparatus are arranged in the order of collection time. The collection time interval between adjacent two frames of images is the same. For example, when the frame rate is set to 25 FPS, the collection time interval between adjacent two frames of images in the acquired images is 1/25 second. Therefore, the collection interval time between two frames of images can be calculated based on the interval frame number.

In some embodiments, when at least two coincident point coordinates are detected in the time-series coordinate data, the interval frame number between the hand action images corresponding to each coincident point coordinate can be calculated. For example, when the preset unbinding action is a double-tap action, the interval frame number between the hand action images corresponding to two adjacent coincident point coordinates is calculated. When the interval frame number is less than the preset interval frame number, it is determined that the hand action of the current user has triggered the preset unbinding action. When the preset unbinding action is triggered, the intelligent wearable device generates the device unbinding instruction. When the interval frame number is greater than the preset interval frame number, it is determined that the hand action of the current user has not triggered the preset unbinding action, and the intelligent wearable device does not need to respond to this hand action.

Step S202: Based on the device unbinding instruction, unbind the binding state between the mobile terminal and the extended screen component, so that the intelligent wearable device and the mobile terminal are in the extended screen interaction state.

In some embodiments, after the binding state between the mobile terminal and the extended screen component is unbound, the extended screen component is fixedly displayed on the display screen of the intelligent wearable device and does not move with the movement of the mobile terminal. At this time, the mobile terminal can be used as a pointing device. When the user holds the mobile terminal to move or tap, the intelligent wearable device tracks and calculates a corner point coordinate of the mobile terminal (such as the upper left corner coordinate) in real time, and identifies the actions of the mobile terminal.

In this embodiment, by using the image acquisition apparatus to identify the hand action made by the current user, and when it is determined that the hand action made by the current user is the preset unbinding action, the device unbinding instruction is triggered and generated. According to the device unbinding instruction, the binding state between the mobile terminal and the extended screen component is unbound, so that the extended screen component is fixedly mapped in the display interface of the intelligent wearable device. This facilitates the intelligent wearable device to track and identify the feature points of the mobile terminal, thereby identify the interaction actions made by the current user operating the mobile terminal, allowing the current user to directly operate the extended screen component through the display interface of the intelligent wearable device, and improving the convenience of the interaction functionality between the intelligent wearable device and the mobile terminal.

Referring to FIG. 4. FIG. 4 is a schematic flowchart of a method for interaction between an intelligent wearable device and a mobile terminal according to a third embodiment of the present disclosure.

As shown in FIG. 4, based on the embodiment shown in FIG. 3, before step S201, the method further includes:

Step S301: Based on the image acquisition apparatus, acquire contour coordinates of the mobile terminal.

In some embodiments, the intelligent wearable device identifies the contour of the mobile terminal through the image acquisition apparatus, and then calculates the contour coordinates of the mobile terminal in the two-dimensional coordinate system of the intelligent wearable device through a computer vision algorithm.

In some embodiments, computer vision refers to enabling computers and systems to obtain meaningful information from images, videos, and other visual inputs, and take action or provide suggestions based on this information. Computer vision trains machines rely on cameras, data, and computer vision algorithms to achieve functions such as distinguishing objects, object distance, whether objects are moving or not, and whether there is a problem with the image. Computer vision algorithms may include feature extraction, feature point tracking, coordinate calculation, etc.

In some embodiments, feature extraction and matching is an important task in many computer vision applications, widely used in structure from motion, image retrieval, object detection, and other fields. Features may be specific structures in the image, such as points, edges, or objects.

In some embodiments, feature point tracking algorithms do not track the target as a whole, but rather match and track a set of feature points (such as boundary lines, centroids, corner points, etc.) in consecutive frame images. Feature-based tracking methods mainly include two steps: feature extraction and matching. The advantage of this type of tracking method is that even if the target in the scene is partially occluded, as long as the feature points are visible, continuous tracking of the target can be achieved.

In some embodiments, coordinate calculation involves calculating the position coordinates of the target feature points in the coordinate system. Because the images acquired by the image acquisition apparatus of the intelligent wearable device are all within the display interface range of the intelligent wearable device, the images acquired by the image acquisition apparatus correspond to the same coordinate system. As long as the contour feature points of the mobile terminal are extracted, and then the positions of the contour feature points in the image are calculated, the contour coordinates of the mobile terminal can be obtained.

Step S302: Obtain a relative positional relationship between at least one extended screen component and the mobile terminal.

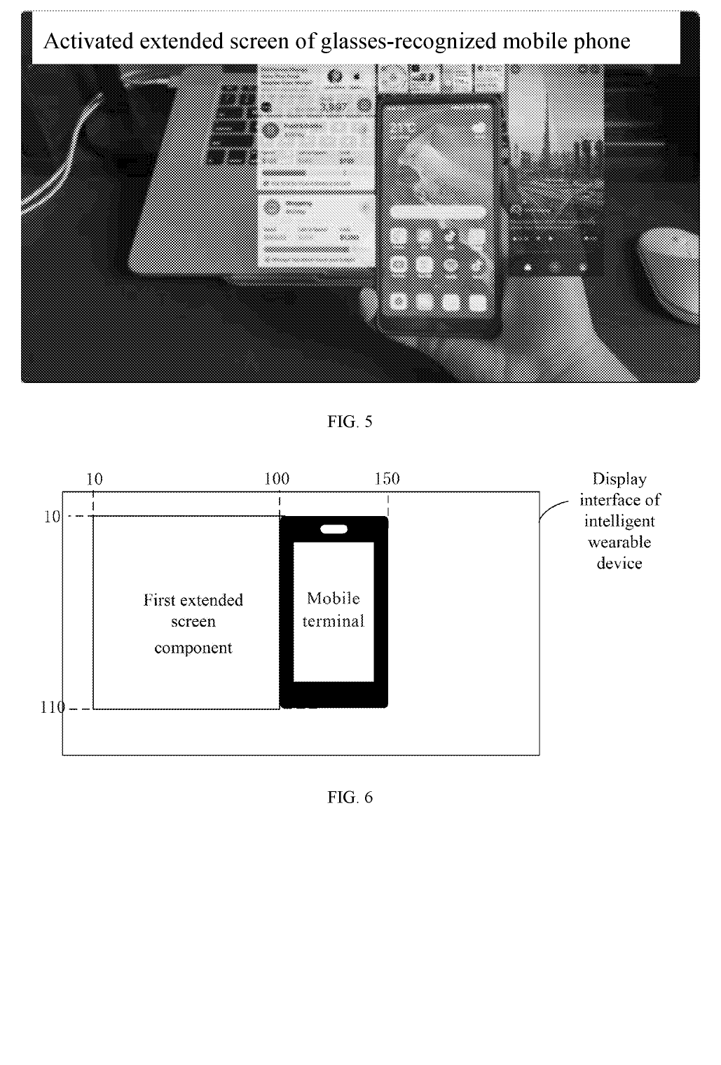

In some embodiments, as shown in FIG. 5, the relative positional relationship between the extended screen component and the mobile terminal depends on the position of the application corresponding to each extended screen component on the mobile terminal's screen. The extended screen components can be distributed around the mobile terminal.

In some embodiments, according to the distribution position and arrangement order of the applications on the mobile terminal, when implementing the mapping of the extended screen components, the distribution positions of the extended screen components are arranged in sequence according to the distribution positions and arrangement order of the applications. When there are multiple applications, the distribution of the multiple applications on the mobile terminal is generally arranged in rows and columns, meaning the distribution position of each application on the mobile terminal can be represented by rows and columns. For example, Application 1—first row, third column, etc.

In some embodiments, the extended screen components can be mapped directly onto the display screen of the intelligent wearable device according to the distribution position of the applications, or the extended screen components can be mapped to the side of the mobile terminal according to columns and rows. For example, the extended screen components corresponding to the first row of applications are mapped above the mobile terminal, and each extended screen component is arranged according to the arrangement order of the applications; the extended screen components corresponding to the first column of applications are mapped to the left of the mobile terminal, etc.

In some embodiments, in the display interface of the intelligent wearable device, the contour of the mobile terminal can be taken as the center, and according to the position of the desktop application corresponding to the extended screen component on the mobile terminal's screen, they are arranged in sequence on the side of the mobile terminal. For example, when the first desktop application is located at the left middle position of the mobile terminal's screen, then the extended screen component corresponding to this first desktop application is enlarged and displayed at the left middle position of the mobile terminal's contour in the display interface of the intelligent wearable device.

Step S303: Based on the contour coordinates of the mobile terminal and the relative positional relationship, render the extended screen component on the display interface of the intelligent wearable device to activate an extended screen mode; in which the mobile terminal and the extended screen component are in a bound state, under the extended screen mode.

In some embodiments, according to the contour coordinates of the mobile terminal and the relative positional relationship, the regional coordinates of each extended screen component in the display interface of the intelligent wearable device corresponding to the extended screen component region are calculated, and then the extended screen component is mapped and displayed in the corresponding extended screen component region in the display interface, completing the activation of the extended screen mode. For example, as shown in FIG. 6, the first extended screen component is located at the left of the mobile terminal, and this first extended screen component is on the left side of the mobile terminal. At this time, the contour coordinates of the mobile terminal can be ((100,10), (150,10), (100,110), (150,110)). According to the relative positional relationship between the mobile terminal and the first extended screen component, the regional coordinates of the extended screen component region corresponding to the first extended screen component can be calculated as ((10,10), (100,10), (10,110), (100,110)).

In some embodiments, the method further includes: obtaining first size information of the mobile terminal and second size information of the extended screen component; based on the first size information, the second size information, the relative positional relationship, and the contour coordinates of the mobile terminal, calculating diagonal coordinate information of the extended screen component in the display interface; based on the diagonal coordinate information, determining the extended screen component region corresponding to each extended screen component. The first size information of the mobile terminal includes the actual device size of the mobile terminal, including length size, width size, etc.

In some embodiments, the first size information of the mobile terminal is known and can be obtained by measuring with a size measurement tool or by querying the mobile terminal manufacturer's official website. The current user can preset the second size information of each extended screen component based on the first size information of the mobile terminal. For example, the display size can be enlarged proportionally according to the number of extended screen components, so that the extended screen components can be completely and reasonably displayed around the mobile terminal.

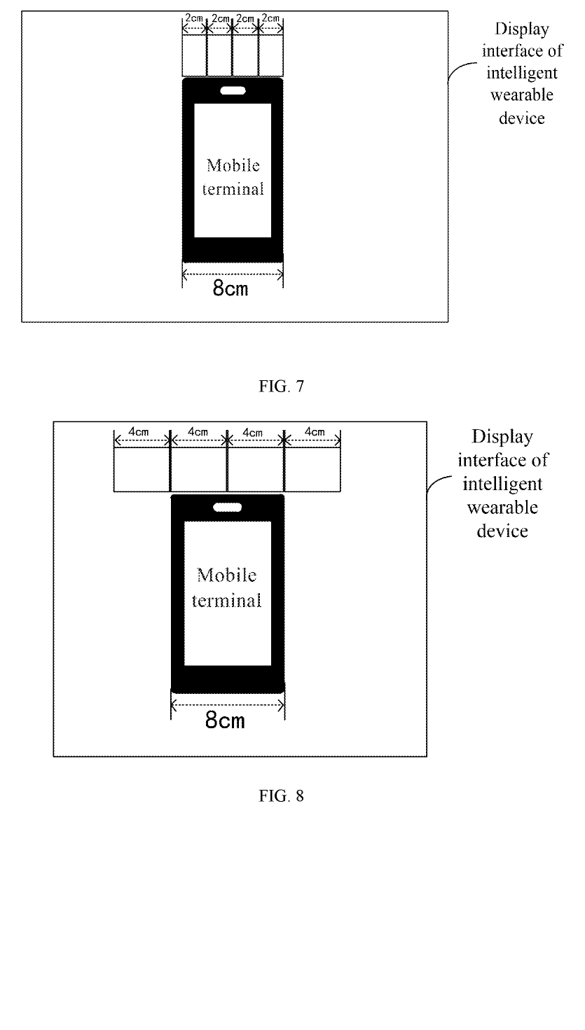

In some embodiments, when the first row of the mobile terminal screen has four applications, and the extended screen components of these four applications are all mapped to the upper side of the mobile terminal, and the first size information of the mobile terminal is 8×16 cm, meaning the length size of the upper side of the mobile terminal is 8 cm, then the maximum second size information of the above four extended screen components can be 2×n cm, meaning the maximum length size of the four extended screen components is 2 cm, and the width can be adjusted according to the actual application situation (as shown in FIG. 7). Or, the maximum length size of the above four extended screen components can be 4×n cm, meaning the maximum length size of the four extended screen components is 4 cm (as shown in FIG. 8), in which the two extended screen components corresponding to the first application and the fourth application are distributed at the two upper diagonal positions of the mobile terminal, respectively.

In some embodiments, according to the relative positional relationship between the mobile terminal and the extended screen component, an enlargement ratio of the extended screen component can be set. For example, when the mobile terminal is rectangular, the enlargement ratio of the extended screen components on the long side can be set larger, and the enlargement ratio of the extended screen components on the short side can be set smaller.

In some embodiments, based on the first size information, the second size information, the relative positional relationship, and the contour coordinates of the mobile terminal, the diagonal coordinate information of the component frame of each extended screen component in the display interface of the intelligent wearable device can be calculated, such as the top-left corner coordinates and the bottom-right corner coordinates. Based on the diagonal coordinate information, the area range where each extended screen component is located in the display interface of the intelligent wearable device can be represented.

In some embodiments, based on the contour coordinates of the mobile terminal, the pixel size of the mobile terminal in the two-dimensional coordinate system is calculated, i.e., the number of pixels occupied by the length of the mobile terminal and the number of pixels occupied by the width. The ratio of the first size information to the pixel size is the size ratio between the actual device size and the pixel size of the two-dimensional coordinate system. The ratio of the second size information to the size ratio is the pixel size of the extended screen component. According to the relative positional relationship and the contour coordinates of the mobile terminal, the starting point coordinates of each extended screen component in the display interface can be known. Based on the starting point coordinates and the pixel size corresponding to each extended screen component, the diagonal coordinate information of the component frame of each extended screen component can be calculated, thereby obtaining the extended screen component region corresponding to each extended screen component.

In this embodiment, by using the image acquisition apparatus to acquire the contour coordinates of the mobile terminal, the position of the mobile terminal in the display interface of the intelligent wearable device is determined. Then, according to the relative positional relationship between the extended screen component and the mobile terminal, the position of the extended screen component in the display interface of the intelligent wearable device is determined, thereby achieving precise mapping of the extended screen component, avoiding confusion in the mapping position of the extended screen component, adapting to the user's usage habits, and improving the user experience of the interaction functionality between the intelligent wearable device and the mobile terminal.

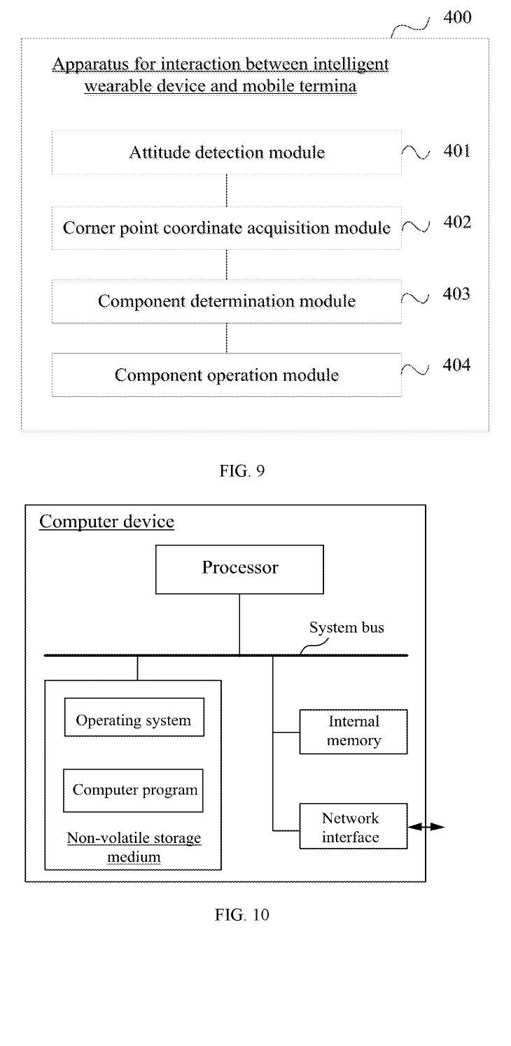

Referring to FIG. 9. FIG. 9 is a schematic structural diagram of an apparatus for interaction between an intelligent wearable device and a mobile terminal according to a first embodiment of the present disclosure. This apparatus for interaction between an intelligent wearable device and a mobile terminal is used to execute the aforementioned method for interaction between an intelligent wearable device and a mobile terminal.

As shown in FIG. 9, the apparatus 400 for interaction between an intelligent wearable device and a mobile terminal includes: an attitude detection module 401, a corner point coordinate acquisition module 402, a component determination module 403, and a component operation module 404.

The attitude detection module 401 is configured to detect a current attitude of the mobile terminal when the intelligent wearable device and the mobile terminal are in an extended screen interaction state.

The corner point coordinate acquisition module 402 is configured to acquire corner point coordinates of a target corner point on the mobile terminal when it is detected that the current attitude of the mobile terminal matches a preset interaction operation action.

The component determination module 403 is configured to determine a target extended screen component based on an extended screen component region corresponding to the corner point coordinates.

The component operation module 404 is configured to execute a target operation on the target extended screen component based on a component operation instruction corresponding to the gesture operation action when a current gesture action of a current user matches a preset gesture operation action.

It should be noted that those skilled in the art can clearly understand that, for the convenience and brevity of description, the specific working processes of the described apparatus and each module can refer to the corresponding processes in the aforementioned embodiments of the method for interaction between an intelligent wearable device and a mobile terminal, which will not be repeated here.

The apparatus provided in the above embodiments can be implemented in the form of a computer program, which can run on a computer device as shown in FIG. 10.

Referring to FIG. 10. FIG. 10 is a schematic block diagram of a structure of a computer device according to an embodiment of the present disclosure. The computer device can be a server.

Referring to FIG. 10, the computer device includes a processor, a memory, and a network interface connected via a system bus. The memory may include a non-volatile storage medium and an internal memory.

The non-volatile storage medium can store an operating system and a computer program. The computer program includes program instructions which, when executed, can cause the processor to execute any one of the methods for interaction between an intelligent wearable device and a mobile terminal.

The processor is used to provide computing and control capabilities to support the operation of the entire computer device.

The internal memory provides an environment for the operation of the computer program in the non-volatile storage medium. When the computer program is executed by the processor, it can cause the processor to execute any one of the methods for interaction between an intelligent wearable device and a mobile terminal.

The network interface is used for network communication, such as sending assigned tasks. Those skilled in the art can understand that the structure shown in FIG. 10 is a block diagram of a part of the structure related to the solution of the present disclosure, and does not constitute a limitation on the computer device to which the solution of the present disclosure is applied. The specific computer device may include more or fewer components than those shown in the figure, or combine some components, or have different component arrangements.

It should be understood that the processor may be a Central Processing Unit (CPU), or it may be other general-purpose processors, Digital Signal Processors (DSP), Application Specific Integrated Circuits (ASIC), Field-Programmable Gate Arrays (FPGA) or other programmable logic devices, discrete gate or transistor logic devices, discrete hardware components, etc. The general-purpose processor may be a microprocessor, or the processor may be any conventional processor, etc.

An embodiment of the present disclosure further provides a computer-readable storage medium. The computer-readable storage medium stores a computer program. The computer program includes program instructions. When the program instructions are executed by the processor, any one of the methods for interaction between an intelligent wearable device and a mobile terminal provided by the embodiments of the present disclosure is implemented.

The computer-readable storage medium may be an internal storage unit of the computer device described in the foregoing embodiments, such as a hard disk or memory of the computer device. The computer-readable storage medium may also be an external storage device of the computer device, such as a plug-in hard disk equipped on the computer device, a Smart Media Card (SMC), a Secure Digital (SD) card, a Flash Card, etc.

The present disclosure provides a method and an apparatus for interaction between intelligent wearable device and mobile terminal, a device, and a storage medium. In the method, when the intelligent wearable device and the mobile terminal are in an extended screen interaction state, the intelligent wearable device detects the current attitude of the mobile terminal and matches the current attitude of the mobile terminal with a preset interaction operation action; and when the current attitude matches the preset interaction operation action, an operation recognition process for the extended screen component is triggered, improving the accuracy of component operation and avoiding false triggering of operations. By acquiring the corner point coordinates of the target corner point on the mobile terminal, the target extended screen component that the current user intends to operate is determined based on the extended screen component region where the corner point coordinates are located, achieving precise identification and selection of the extended screen component. By comparing the current gesture action of the current user with a preset gesture operation action, the gesture operation action matching the current gesture action is determined, and then the component operation instruction corresponding to that gesture operation action is generated, and the target operation is executed on the target extended screen component according to the component operation instruction, allowing the current user to directly operate the extended screen component on the display interface of the intelligent wearable device, thereby improving the interaction efficiency between the intelligent wearable device and the mobile terminal and enhancing the user experience.

The foregoing descriptions are merely specific embodiments of the present disclosure, but the protection scope of the present disclosure is not limited thereto. Any person skilled in the art can easily think of various equivalent modifications or substitutions within the technical scope disclosed in the present disclosure, and these modifications or substitutions should be covered within the protection scope of the present disclosure. Therefore, the protection scope of the present disclosure should be subject to the protection scope of the claims.

What is claimed is:

1. A method for interaction between an intelligent wearable device and a mobile terminal, the method comprising:
detecting, by the intelligent wearable device, a current attitude of the mobile terminal, when the intelligent wearable device and the mobile terminal are in an extended screen interaction state;
acquiring corner point coordinates of a target corner point on the mobile terminal, when it is detected that the current attitude of the mobile terminal matches a preset interaction operation action;
determining a target extended screen component, based on an extended screen component region corresponding to the corner point coordinates; and
executing a target operation on the target extended screen component based on a component operation instruction corresponding to a preset gesture operation action, when a current gesture action of a current user matches the preset gesture operation action.

2. The method according to claim 1, prior to the detecting the current attitude of the mobile terminal when the intelligent wearable device and the mobile terminal are in the extended screen interaction state, the method further comprises:
identifying, based on an image acquisition apparatus, a preset unbinding action made by the current user, and generating a device unbinding instruction; and
unbinding a binding state between the mobile terminal and the extended screen component based on the device unbinding instruction, so that the intelligent wearable device and the mobile terminal are in the extended screen interaction state.

3. The method according to claim 2, wherein the identifying, based on an image acquisition apparatus, a preset unbinding action made by the current user, and generating a device unbinding instruction comprises:
acquiring, based on the image acquisition apparatus, hand action images of the current user to obtain a hand image group, wherein the hand action image group comprises at least two of the hand action images;
extracting, based on a preset key point tracking algorithm, point coordinates of target key points in the hand action images to obtain time-series coordinate data of the target key points;
when at least two coincident point coordinates are detected in the time-series coordinate data, calculating a collection time interval of each of the coincident point coordinates based on collection times corresponding to each of the coincident point coordinates; and
when the collection time interval is less than a preset time interval, determining that a hand action of the current user is the preset unbinding action, and generating the device unbinding instruction.

4. The method according to claim 3, when at least two coincident point coordinates are detected in the time-series coordinate data, the method further comprises:
determining, based on the time-series coordinate data, an interval frame number between the hand action images corresponding to each of the coincident point coordinates; and
when the interval frame number is less than a preset interval frame number, determining that the hand action of the current user is the preset unbinding action, and generating the device unbinding instruction.

5. The method according to claim 2, prior to the identifying, based on an image acquisition apparatus, a preset unbinding action made by the current user, and generating a device unbinding instruction, the method further comprises:
acquiring, based on the image acquisition apparatus, contour coordinates of the mobile terminal;
obtaining a relative positional relationship between at least one extended screen component and the mobile terminal; and
rendering the extended screen component on a display interface of the intelligent wearable device based on the contour coordinates of the mobile terminal and the relative positional relationship, to activate an extended screen mode, wherein in the extended screen mode, the mobile terminal and the extended screen component are in a bound state.

6. The method according to claim 5, prior to the rendering the extended screen component on a display interface of the intelligent wearable device based on the contour coordinates of the mobile terminal and the relative positional relationship to activate an extended screen mode, the method further comprises:
obtaining first size information of the mobile terminal and second size information of the extended screen component;
calculating diagonal coordinate information of the extended screen component in the display interface based on the first size information, the second size information, the relative positional relationship, and the contour coordinates of the mobile terminal; and
determining the extended screen component region corresponding to each extended screen component based on the diagonal coordinate information.

7. The method according to claim 1, prior to the executing a target operation on the target extended screen component based on a component operation instruction corresponding to a preset gesture operation action when a current gesture action of a current user matches the preset gesture operation action, the method further comprises:
obtaining a gesture instruction library, wherein the gesture instruction library comprises at least one the gesture operation action and a component operation instruction corresponding to each gesture operation action;
comparing, based on a gesture recognition algorithm, the current gesture action with each gesture operation action in the gesture instruction library to determine a similarity between the current gesture action and each gesture operation action; and
determining the gesture operation action matching the current gesture action based on the similarity, when the similarity is greater than or equal to a preset similarity.

8. The method according to claim 7, wherein the comparing, based on a gesture recognition algorithm, the current gesture action with each gesture operation action in the gesture instruction library to determine a similarity between the current gesture action and each gesture operation action comprises:
calculating, based on the gesture recognition algorithm, an action trajectory of the current gesture action; and
calculating a similarity between the action trajectory of the current gesture action and an action trajectory of each gesture operation action to determine the similarity between the current gesture action and the gesture operation action.

9. The method according to claim 8, wherein the action trajectory comprises coordinate trajectories of hand key points along a time sequence;
wherein the hand key points comprise joint points and/or fingertip points.

10. The method according to claim 7, wherein the determining the gesture operation action matching the current gesture action based on the similarity when the similarity is greater than or equal to a preset similarity comprises:
when the similarity between the current gesture action and each of multiple gesture operation actions is greater than or equal to the preset similarity, determining that the gesture operation action with a highest similarity matches the current gesture action.

11. The method according to claim 1, wherein the detecting that the current attitude of the mobile terminal matches a preset interaction operation action comprises:
calculating a similarity between the current attitude and the interaction operation action; and
determining that the current attitude of the mobile terminal matches the preset interaction operation action when the similarity between the current attitude and the interaction operation action is greater than or equal to a similarity threshold.

12. The method according to claim 1, wherein the acquiring corner point coordinates of a target corner point on the mobile terminal comprises:
calculating intersection coordinates of edge lines of the mobile terminal based on contour coordinates of the mobile terminal; and
defining, based on a correspondence between each arc corner of the mobile terminal and each of the intersection coordinates, an arc point coordinate closest to a corresponding intersection coordinate on the arc corner as the corner point coordinates.

13. The method according to claim 1, wherein the determining a target extended screen component based on an extended screen component region corresponding to the corner point coordinates comprises:
determining that the extended screen component corresponding to the extended screen component region is the target extended screen component, when landing point coordinates of the target corner point to a range of the same extended screen component region within a preset time.

14. The method according to claim 1, wherein the determining a target extended screen component based on an extended screen component region corresponding to the corner point coordinates further comprises:
determining that the extended screen component corresponding to the extended screen component region is the target extended screen component, when a dwell time of intersection coordinates of the target corner point in any extended screen component region reaches a preset duration threshold.

15. The method according to claim 1, wherein the determining a target extended screen component based on an extended screen component region corresponding to the corner point coordinates further comprises:
when the corner point coordinates do not belong to any one of the extended screen component regions, calculating distances between the corner point coordinates and a midpoint position of each extended screen component region, and identifying a shortest distance among the distances; and
determining the extended screen component corresponding to the extended screen component region with the shortest distance as the target extended screen component.

16. The method according to claim 1, wherein the interaction operation action comprises a double-tap action, a hold gesture maintained for a preset duration, and a slide action.

17. The method according to claim 1, wherein the detecting a current attitude of the mobile terminal comprises:
identifying contour information, corner point coordinate information, and a movement trajectory of the mobile terminal based on an image acquisition apparatus, when the mobile terminal moves into a collection image of the image acquisition apparatus; and
determining the current attitude of the mobile terminal, based on the contour information, the corner point coordinate information, and the movement trajectory.

18. An apparatus for interaction between an intelligent wearable device and a mobile terminal, comprises:
one or more processors; and
a memory, configured to store one or more programs, wherein the one or more programs, when executed by the one or more processors, cause the one or more processors to execute operations of:
detecting a current attitude of the mobile terminal when the intelligent wearable device and the mobile terminal are in an extended screen interaction state;
acquiring corner point coordinates of a target corner point on the mobile terminal when it is detected that the current attitude of the mobile terminal matches a preset interaction operation action;
determining a target extended screen component based on an extended screen component region corresponding to the corner point coordinates; and
executing a target operation on the target extended screen component based on a component operation instruction corresponding to the gesture operation action, when a current gesture action of a current user matches a preset gesture operation action.

19. A computer device, comprising: a processor, a memory, and a computer program stored on the memory and executable by the processor; when the computer program is executed by the processor, the method according to claim 1 is implemented.

20. A non-transitory computer-readable storage medium, wherein the computer-readable storage medium has stored thereon a computer program, wherein when the computer program is executed by a processor, the method according to claim 1 is implemented.
